(19) United States
(12) Patent Application Publication
(10) Pub. No.: US 2020/0167680 A1
(43) Pub. Date: May 28, 2020

(54) EXPERIMENTAL DESIGN OPTIMIZATION DEVICE, EXPERIMENTAL DESIGN OPTIMIZATION METHOD, AND EXPERIMENTAL DESIGN OPTIMIZATION PROGRAM

(71) Applicant: NEC CORPORATION, Tokyo (JP)

(72) Inventor: Akihiro YABE, Minato-ku, Tokyo (JP)

(73) Assignee: NEC CORPORATION, Tokyo (JP)

(21) Appl. No.: 16/612,928

(22) PCT Filed: May 17, 2017
(86) PCT No.: PCT/JP2017/018484

§ 371 Date: Nov. 12, 2019

(51) Int. Cl. G06N 7/00; G06N 20/00

(52) U.S. Cl. CPC G06N 7/005; G06N 20/00

(57) ABSTRACT

A first reception unit 81 receives, as an input, a graph including: a plurality of nodes representing experimental operations; a plurality of nodes representing results of the operations; and edges representing cause-and-effect relationships between the experimental operations and the operation results. A second reception unit 82 receives, as an input, either information indicating the degree of cause-and-effect relationship between each experimental operation and each operation result or past experimental results from which the strength of each cause-and-effect relationship can be estimated. On the basis of the input received by the first reception unit 81 and the information received by the second reception unit 82, an output unit 83 outputs the order in which a plurality of experimental operations are to be performed.

### TECHNICAL FIELD

The present invention relates to an experimental design optimization device, an experimental design optimization method, and an experimental design optimization program for optimizing an experimental design, which is performed on the basis of operations.

### BACKGROUND ART

In the pharmaceutical and agricultural fields, the optimality of various combinations is generally found by experiments. For example, in the agricultural field, a combination of fertilizers may influence the degree of plant growth. Furthermore, in the pharmaceutical field, medicine preparation assumed to be effective may influence each disease treatment.

Incidentally, in the pharmaceutical and agricultural fields, a single combination does not always provide 100% results due to a plurality of unknown factors. Therefore, the probability that an action of achieving a target combination influences a supposed result (the degree of influence) is derived by experimenting the same operation more than once. Hereinafter, each action performed to derive a certain result will be referred to as “operation.” For example, in the above example, the selection of a fertilizer amount, the presence or absence of medicine preparation, and the like are assumed to be operations.

Performing a lot of experiments improves the calculation accuracy of the probability of influencing a result. An increase in the combinations of operations, however, also increases the number of times that experiments are performed accordingly. Therefore, it is preferable that the number of combinations to be candidates can be reduced.

For example, Paten Literature (PTL) 1 describes a method of deciding a large number of design parameters efficiently without reworking in product development in which a large number of design parameters or product features are handled and the design parameters or the product features have a mutual interaction. In the method described in PTL 1, there is prepared a model in which a mutual relationship between design parameters is structured, and then a large experiment is assigned to each design parameter group information acquired from the model after the structuring process, and large experimental design information is output. The large experimental design information includes a large experiment ID assigned to each design parameter group, an experiment order, a corresponding design parameter list, an interface parameter with a prior experiment, and the number of experimental levels and level values thereof.

### CITATION LIST

### Patent Literature

PTL 1: Japanese Patent Application Laid-Open No. 2006-344200

### SUMMARY OF INVENTION

### Technical Problem

Hereinafter, description will be made on a method of deriving the degree of influence by using a concrete example. In this specification, it is supposed that a single result is obtained by a single operation to simplify the description. An operation of representing whether insulin is administered is indicated by x∈{0, 1} (insulin is not administered if x=0, but insulin is administered if x=1). In addition, as a result of the operation, a result representing whether the blood glucose level is high or low is indicated by u∈{0, 1} (it is assumed that a blood glucose level is assumed to be high if u=0 and that the blood glucose level is assumed to be low if u=1).

FIG. 11 is an explanatory diagram illustrating an example of a supposed result. Even if the result illustrated in FIG. 11 is a result that should be originally obtained, the result is not actually unknown. Therefore, the result illustrated in FIG. 11 is estimated from obtained experimental results by performing the above operation more than once.

For example, it is supposed that a result of a high blood glucose level (u=0) is obtained 72 times while a result of a low blood glucose level (u=1) is obtained 28 times when an experiment with insulin not administered (x=0) is performed 100 times. From the experimental result, a result close to the result on the table illustrated in FIG. 11 is estimated. The same applies to an experiment with insulin administered (x=1). The above is the meaning of measuring the effect.

It is easy to measure the effect of a single operation as described above. If, however, an effect is caused by a plurality of operations influencing each other, it is sometimes required to solve a problem of finding optimum operations.

FIG. 12 is an explanatory diagram illustrating an example of a graph illustrating a cause-and-effect relationship between an operation and a result. In FIG. 12, it is assumed that x₁ to x₃ represent an operation of determining whether or not nitrogenous fertilizers of three types are administered, x₄ to x₆ represent an operation of determining whether or not phosphorus fertilizers of three types are administered, and x₇ to x₉ represent an operation of determining whether or not potassium fertilizers of three types are administered. Moreover, it is assumed that u₁ to u₃ represent the soil volume of nitrogen, the soil volume of phosphorus, and the soil volume of potassium, respectively. Furthermore, it is assumed that y represents whether or not the plant has grown well. With these settings, it is assumed that an optimum fertilizer administration strategy is required to be found.

First, an interaction occurs between the respective fertilizers. For example, x₁ to x₃ have an interaction that administration of any one is enough, x₁ and x₄ have an interaction that administering both of x₁ and x₄ generates a synergistic effect, and the like. If all operations have interactions, the experimental settings cannot be reduced in the method described in PTL 1. Therefore, for example, if a certain operation includes two types of candidates and there could be n types of the operations, the number of types of experiments exponentially increases (in this case, O(2ⁿ)) and therefore the number of experiments to be performed also increases in the exponential order. Accordingly, to find an optimum strategy with a less number of experiments, it is important to perform an experimental design optimally.

In the case where the soil volume of nitrogen is able to be measured, it is possible to consider the effect of x₁ to x₃ applied to the soil volume of nitrogen and the effect of the soil volume of nitrogen applied to growth separately. In the example illustrated in FIG. 12, an efficient separating method is half obvious. The separating method, however, is not obvious if operations and observed values are supplied in a general cause-and-effect graph.

Moreover, in the method described in PTL 1, a design parameter group having less interaction is extracted and an experimental design based on the design parameter group is created. If, however, all operations have interactions as described above, the experimental design is ineffective to reduce the number of experiments. With respect to the parameters having a cause-and-effect relationship, it is preferable that an experimental design can be created independently of the presence or absence of an interaction.

Therefore, it is an object of the present invention to provide an experimental design optimization device, an experimental design optimization method, and an experimental design optimization program capable of optimizing an experimental design in consideration of a cause-and-effect relationship present behind.

### Solution to Problem

An experimental design optimization device according to the present invention includes: a first reception unit that receives, as an input, a graph including: a plurality of nodes representing experimental operations; a plurality of nodes representing operation results; and edges representing cause-and-effect relationships between the experimental operations and the operation results; a second reception unit that receives, as an input, either information indicating the degree of cause-and-effect relationship between each experimental operation and each operation result, or past experimental results from which the strength of each cause-and-effect relationship can be estimated; and an output unit that outputs the order in which a plurality of the experimental operations are to be performed on the basis of the input received by the first reception unit and the information received by the second reception unit.

An experimental design optimization method according to the present invention includes: receiving, as an input, a graph including: a plurality of nodes representing experimental operations; a plurality of nodes representing operation results; and edges representing cause-and-effect relationships between the experimental operations and the operation results; receiving, as an input, either information indicating the degree of cause-and-effect relationship between each experimental operation and each operation result, or past experimental results from which the strength of each cause-and-effect relationship can be estimated; and outputting the order in which a plurality of the experimental operations are to be performed on the basis of the received graph and the information indicating the degree or the experimental result.

An experimental design optimization program according to the present invention causes a computer to perform: a first reception process of receiving, as an input, a graph including: a plurality of nodes representing experimental operations; a plurality of nodes representing operation results; and edges representing cause-and-effect relationships between the experimental operations and the operation results; a second reception process of receiving, as an input, either information indicating the degree of cause-and-effect relationship between each experimental operation and each operation result, or past experimental results from which the strength of each cause-and-effect relationship can be estimated; and an output process of outputting the order in which a plurality of the experimental operations are to be performed on the basis of the input received by the first reception unit and the information received by the second reception unit.

### Advantageous Effects of Invention

The present invention provides a technical effect enabling an optimization of an experimental design in consideration of a cause-and-effect relationship present behind.

### BRIEF DESCRIPTION OF DRAWINGS

FIG. 1 is a block diagram illustrating an exemplary embodiment of an experimental design optimization device according to the present invention.

FIG. 2 is an explanatory diagram illustrating an example of a graph representing a cause-and-effect relationship between an operation and a result.

FIG. 3 is an explanatory diagram illustrating another example of a graph representing cause-and-effect relationships between operations and results.

FIG. 4 is an explanatory diagram illustrating an example of experimental results.

FIG. 5 is an explanatory diagram illustrating still another example of a graph representing cause-and-effect relationships between operations and results.

FIG. 6 is a flowchart illustrating an example of operation of the experimental design optimization device.

FIG. 7 is an explanatory diagram illustrating an example of an experimental design.

FIG. 8 is an explanatory diagram illustrating an example of the number of experiments.

FIG. 9 is a block diagram illustrating an outline of an information processing system according to the present invention.

FIG. 10 is a schematic block diagram illustrating the configuration of a computer according to at least one exemplary embodiment.

FIG. 11 is an explanatory diagram illustrating an example of a supposed result.

FIG. 12 is an explanatory diagram illustrating an example of a graph representing a cause-and-effect relationship between an operation and a result.

### DESCRIPTION OF EMBODIMENT

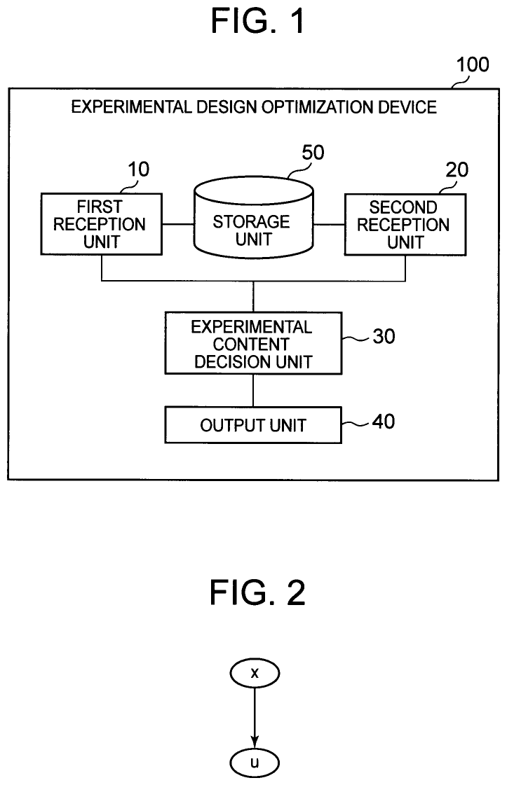

Hereinafter, exemplary embodiments of the present invention will be described with reference to appended drawings. FIG. 1 is a block diagram illustrating an exemplary embodiment of an experimental design optimization device according to the present invention. The experimental design optimization device 100 of this exemplary embodiment includes a first reception unit 10, a second reception unit 20, an experimental content decision unit 30, an output unit 40, and a storage unit 50. In addition, the first reception unit 10 and the second reception unit 20 may be implemented by a single reception unit.

The storage unit 50 stores information received by the first reception unit 10 and information received by the second reception unit 20.

The first reception unit 10 receives, as an input, an operation performed in an experiment, a result observed by the operation (hereinafter, referred to as “observed value” in some cases), and information including a cause-and-effect relationship between the operation and the result. In the case where another result is obtained on the basis of one or more certain results, the cause-and-effect relationship also includes a cause-and-effect relationship between the results. The operation input here is an operation effective to identify a final output. Moreover, the observed result can also be said as “value that can be observed by the influence of the operation (observed value).”

From past knowledge, an operation that can influence a certain result is able to be identified. Therefore, in the present invention, it is assumed that a cause-and-effect relationship in which a certain operation influences a result is already known. Furthermore, in the present invention, it is assumed that the cause-and-effect relationship is represented by a directed acyclic graph (DAG). In the following description, the directed acyclic graph will be simply referred to as “graph.”

FIG. 2 is an explanatory diagram illustrating an example of a graph representing a cause-and-effect relationship between an operation and a result. Anode x illustrated in FIG. 2 represents an operation and a node u represents a result. Moreover, an arrow connecting the operation and the result represents the cause-and-effect relationship between the operation and the result. In the above example illustrated in FIG. 11, x corresponds to an operation representing “whether or not insulin is administered” and u corresponds to a result representing “whether the blood glucose level is high or low.”

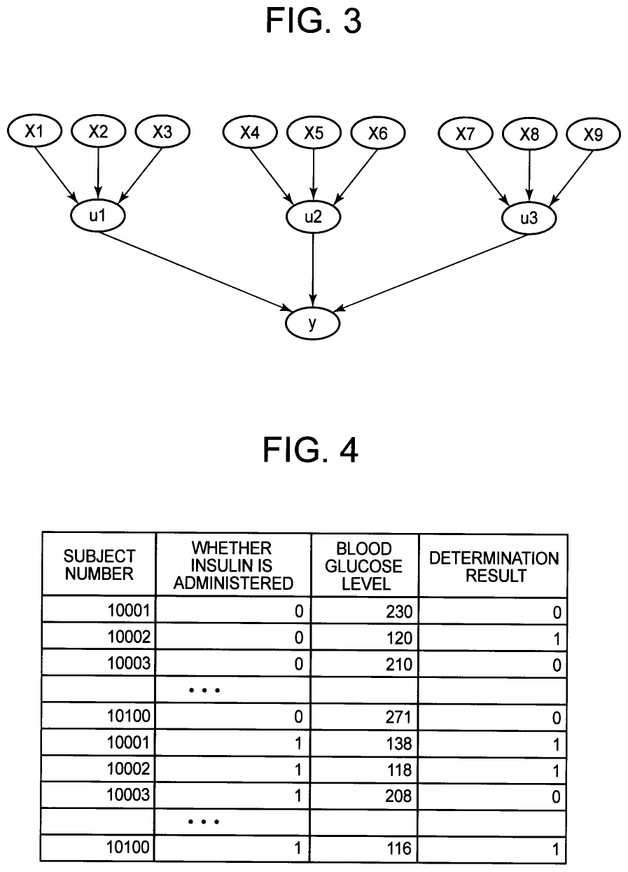

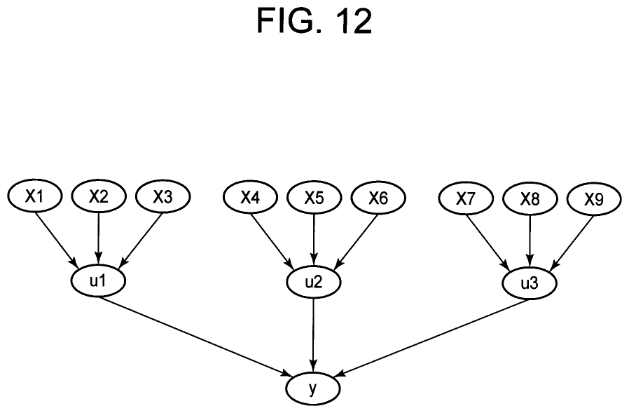

FIG. 3 is an explanatory diagram illustrating another example of a graph representing a cause-and-effect relationship between an operation and a result. The graph representing the cause-and-effect relationship illustrated in FIG. 3 is the same as the graph representing a cause-and-effect relationship illustrated in FIG. 12. Nodes x₁ to x₉ illustrated in FIG. 3 represent operations, nodes u₁ to u₃ represent results (intermediate results), and a node y represents a final result. In the example illustrated in FIG. 3, an operation representing whether or not the i-th drug administration is performed is indicated by xᵢ∈{0, 1} (a drug is not administered if xᵢ=0, but a drug is administered if xᵢ=1). Moreover, a result representing whether or not the j-th measured value (for example, a blood pressure, a blood glucose level, or the like) is better than a predetermined standard is indicated by uⱼ∈{0, 1} (the result is assumed to be bad if uⱼ=0, and the result is assumed to be good if uⱼ=1). Furthermore, a final result representing whether or not health is achieved is indicated by y∈{0, 1} (the final result is assumed to be bad if y=0, and the final result is assumed to be good if y=1).

The example in FIG. 3 illustrates that a corresponding probabilistic observation is obtained upon the decision of each xᵢ. In other words, the example illustrates that each observed value is influenced by the value (operation) of the node at the source of the arrow. In addition, as illustrated in FIG. 3, the cause-and-effect relationship of the input graph may include not only a cause-and-effect relationship between the operation and result, but also a cause-and-effect relationship between results.

Therefore, the first reception unit 10 of this exemplary embodiment receives, as an input, a graph including a plurality of nodes representing experimental operations, a plurality of nodes representing results of the operations, and edges representing cause-and-effect relationships between the experimental operations and the operation results.

The second reception unit 20 receives, as an input, information indicating the degree of the aforementioned cause-and-effect relationship (specifically, the cause-and-effect relationship between each experimental operation and each operation result). The information indicating the degree of cause-and-effect relationship is specifically the probability of a result obtained when a certain operation is performed. In the following description, the information indicating the degree of cause-and-effect relationship is referred to as “probability indicating the cause-and-effect relationship” or simply as “probability.”

For example, in the example illustrated in FIG. 11, it can be said that the probability indicating the cause-and-effect relationship such that a blood glucose level is low (u=0) when insulin is administered (x=1) is 0.2 from the table illustrated in FIG. 11.

Moreover, the second reception unit 20 may receive, as an input, past experimental results from which the degree of cause-and-effect relationship (probability indicating the cause-and-effect relationship) can be estimated, instead of the probability itself indicating the cause-and-effect relationship. The past experimental results from which the degree of cause-and-effect relationship can be estimated means individual experimental results or an aggregate value of some experimental results.

FIG. 4 is an explanatory diagram illustrating an example of experimental results. The example in FIG. 4 is an example of experimental results indicating blood glucose levels in relation to whether or not insulin is administered. For example, in the case where insulin is not administered to a subject having a subject number 10001 illustrated in FIG. 4 (insulin administration=0), the example illustrates that the subject is determined to have a blood glucose level of 150 and a high blood glucose level (0).

For example, as illustrated in FIG. 4, it is assumed that an experimental result that the blood glucose level is high (u=0) is obtained 72 times and a result that the blood glucose level is low (u=1) is obtained 28 times when an experiment in which insulin is not administered (x=0) is performed 100 times. With the use of this experimental result, the probability indicating a cause-and-effect relationship that the blood glucose level is high (u=0) when insulin is not administered (x=0) can be calculated to be 72/100=0.72. The second reception unit 20 may receive, as an input, the past experimental results from which the degree of each cause-and-effect relationship can be estimated as described above.

The experimental content decision unit 30 decides the content of experimental operations to be performed next (specifically, the order of experimental operations to be performed) on the basis of the input to the first reception unit 10 and the input to the second reception unit 20. The experimental contents decided by the experimental content decision unit 30 are specifically the combination of operations and the number of experiments.

The experimental content decision unit 30 identifies a most likely operation method (hereinafter, sometimes referred to as “intervention method”) in order to achieve a combination of values input to the nodes of the results.

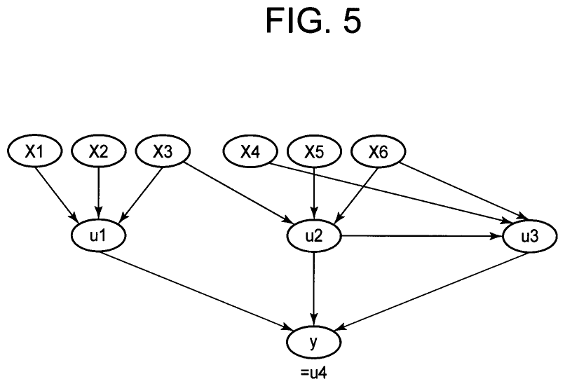

Hereinafter, a method of deciding the experimental contents will be described by using concrete examples. FIG. 5 is an explanatory diagram illustrating still another example of a graph representing cause-and-effect relationships between operations and results. The nodes x₁ to x₆ illustrated in FIG. 5 represent operations, nodes u₁ to u₃ represent results (intermediate results), and a node y represents a final result. Since the node y is also a node representing a result, y=u₄ is assumed in the description.

In the example illustrated in FIG. 5, an operation representing whether or not the i-th use of drug fertilizer is performed is indicated by xᵢ∈{0, 1} (fertilizer is not used if xᵢ=0, but fertilizer is used if xᵢ=1). Moreover, a result representing whether or not the j-th growth state (for example, the size of a leaf, the height of a plant, or the like) is better than a predetermined standard is indicated by uⱼ∈{0, 1} (the result is assumed to be bad if uⱼ=0, and the result is assumed to be good if uⱼ=1). Furthermore, a final result representing the amount of harvest is indicated by y∈{0, 1} (the final result, however, is assumed to be bad if y=0, and the final result is assumed to be good if y=1).

Also in the example of FIG. 5, a corresponding probabilistic observation is obtained upon the decision of each xᵢ. Furthermore, in the example illustrated in FIG. 5, a corresponding probabilistic observation of u₃ is obtained depending on not only the operations x₄ and x₆, but also u₂. The edges belonging to u₁ are rearranged so as to be edges from x₁, x₂, - - - , x₆, - - - u₁, x₂, and x₃.

In this concrete example, it is assumed that experiments can be performed T times. Moreover, in the example illustrated in FIG. 5, a possible value of each node is binary and therefore, if Cᵢ is the number of types of conditional probability representing the strength of each cause-and-effect relationship required to be estimated by a node i of each result, Cᵢ=2^{deg(ui)} is satisfied. Note that, however, deg(uᵢ) represents an in-degree (the number of entering arrows) to the node uᵢ. Therefore, the total number C of the types of experiments supposed in the node illustrated in FIG. 5 satisfies an equation C=ΣᵢCᵢ.

Furthermore, in this concrete example, the number of experiments performed in a node of each result is decided according to a ratio of the type of an experiment performed to estimate a conditional probability in each node, relative to the types of experiments performed in whole. Specifically, if Tᵢ is the number of experiments performed in the node i of each result, an equation Tᵢ=T*(Cᵢ/C) is achieved.

First, it is assumed that a node u₁ of a result that depends only on an operation is selected from the graph. In this case, the experimental content decision unit 30 identifies a combination of operations that influence the result. In the case of the node u₁, nodes influencing the result are x₁, x₂, and x₃, each of which takes two types of values {0, 1}.

Therefore, the experimental content decision unit 30 identifies an intervention method most likely to achieve (x₁, x₂, x₃)=(0, 0, 0), (0, 0, 1), (0, 1, 0), . . . , (1, 1, 1). In this case, the value of {0, 1} is decided according to the operation and therefore the operation may be performed directly.

In this case, the experimental content decision unit 30 decides that C₁=2³ types of experiments are to be performed with respect to the node u₁. Moreover, if the respective types of experiments are equally performed, the experimental content decision unit 30 decides that each type of experiment is to be performed T₁/C₁ times. The experimental content decision unit 30 outputs (x₁, x₂, x₃)=(0, 0, 0), (0, 0, 1), (0, 1, 0), . . . , (1, 1, 1) as an order in which the experimental operations are to be performed, with respect to the node u₁. The same applies to a node u₂.

It is then supposed that a node u₃, which represents a result depending not only on an operation, but also on other results, is selected from the graph. In the case of the node u₃, the experimental content decision unit 30 takes two types of values {0, 1} with respect to x₄, x₆, and u₂, which are nodes influencing the result. Therefore, the experimental content decision unit 30 identifies the most likely operation method to achieve (x₄, x₆, u₂)=(0, 0, 0), (0, 0, 1), (0, 1, 0), . . . , (1, 1, 1).

Specifically, the experimental content decision unit 30 identifies nodes of operations on which the node of the result depends. The nodes of operations on which the node u₂ of the result depends are x₃, x₅, and x₆. In this case, the experimental content decision unit 30 identifies the nodes of the operations on which the node u₂ of the result depends as x₃, x₅, and x₆. The experimental content decision unit 30 identifies the most likely intervention method to achieve a combination of operations influencing the result by using the identified node.

With respect to the node u₂, the implementation probability in the case where the x₃, x₅, and x₆ are supplied are calculated according to a concrete experimental result, similarly to the method for the node u₁. For example, with respect to the operation for which x₆=0 is supposed, it is assumed that the implementation probability achieving u₂=1 is calculated as described below and estimated.

P(u₂=1|(x₃, x₅, x₆))=(0, 0, 0))=0.4

P(u₂=1|(x₃, x₅, x₆))=(0, 1, 0))=0.5

P(u₂=1|(x₃, x₅, x₆))=(1, 0, 0))=0.6

P(u₂=1|(x₃, x₅, x₆))=(1, 1, 0))=0.3

Since u₂ is supposed to take a binary value, the following result is also calculated from the above result.

P(u₂=0|(x₃, x₅, x₆))=(0, 0, 0))=0.6

P(u₂=0|(x₃, x₅, x₆))=(0, 1, 0))=0.5

P(u₂=0|(x₃, x₅, x₆))=(1, 0, 0))=0.4

P(u₂=0|(x₃, x₅, x₆))=(1, 1, 0))=0.7

In this case, a highest probability that u₂ is zero is achieved when (x₃, x₅, x₆)=(1, 1, 0) and the probability is 0.7. Moreover, the value of x₄ is identified as 1 or 0 with probability 1. Therefore, with the operation of (x₃, x₄, x₅, x₆)=(1, 0, 1, 0), the probability of achieving (x₄, x₆, u₂)=(0, 0, 0) is estimated to be 0.7. In other words, the above operation enables an appropriate sample to be obtained with the probability of 70%.

Accordingly, the experimental content decision unit 30 decides that the operation of (x₃, x₄, x₅, x₆)=(1, 0, 1, 0) is to be performed in the case of performing an experiment of (x₄, x₆, u₂)=(0, 0, 0) with respect to the node u₃. The same applies to the type of experiment. Additionally, since one having a low implementation probability occurs with a low probability in the first place, it can be said that it has only a small influence on the final result.

The above content will be described in more detail. In the case where uᵢ illustrated in FIG. 5 is estimated, x₁ to x₃ are able to be directly operated and therefore the condition can be achieved with a 100 percent likelihood. In other words, the conditional probability P(u₁=1|x₁, x₂, x₃) is able to be efficiently estimated. On the other hand, in the case where u₃ is estimated, an aimed experiment is able to be performed with only a 70 percent likelihood, and therefore the efficiency of the estimation decreases.

The final goal is to find an operation having a highest probability of achieving y=1. Attention will be paid to this point. An event represented by (x₄, x₆, u₂)=(0, 0, 0) occurs only with a 70 percent probability for any combination of operations. Therefore, if the probability that the event occurs is low, low estimation accuracy of the conditional probability corresponding to the event does not give a large influence on the estimation of probability of achieving the final goal (y=1). From the above, it is justified that a parameter is estimated by performing experiments sequentially.

In addition, in the case where respective types of experiments are equally performed, the experimental content decision unit 30 decides that each intervention (each type of the experiments) is to be performed T₃/C₃ times, similarly to the node u₁. In other words, an experimenter is to perform an experiment of observation using fertilizers with the combination on the basis of the content.

For example, it is supposed that P(u₃=1|(x₄, x₆, u₂)=(0, 0, 0)) is estimated by this experiment. For example, if experiments are decided to be performed T₃ times in the whole node u₃, eight types of experiments are performed in the node u₃ and therefore an experiment of (x₃, x₄, x₅, x₆)=(1, 0, 1, 0) is assigned T₃/8 times. Then, through this experiment, the number of times that (x₄, x₆, u₂)=(0, 0, 0) and u₃=1 are satisfied is divided by the number of times that (x₄, x₆, u₂)=(0, 0, 0) is satisfied, by which P(u₃=1|(x₄, x₆, u₂)=(0, 0, 0)) is estimated.

If the probability (conditional probability) obtained when the state of the parent node is given with respect to all nodes can be estimated as described above, it is possible to identify an operation method (intervention method) having the highest probability of achieving y=1. The probability of achieving y=1 when x₁ to x₆ are given can be calculated by the following equation 1.

$$[ MATH . 1 ]$$

$$( Equation 1 )$$

$$P ( y = 1 \vert {x}_{1} , {x}_{2} , {x}_{3} , {x}_{4} , {x}_{5} , {x}_{6} ) = {\sum }_{\{ \begin{matrix}Combination \\ of {u }_{1} , {u}_{2} , {u}_{3}\end{matrix} \}} P ( {y}_{1} \vert {u}_{1} , {u}_{2} , {u}_{3} ) P ( {u}_{3} \vert {x}_{4} , {x}_{6} , {u}_{2} ) P ( {u}_{2} \vert {x}_{3} , {x}_{5} , {x}_{6} ) P ( {u}_{1} \vert {x}_{1} , {x}_{2} , {x}_{3} )$$

In the case where the node of a result depends on not only a node of an operation, but also another node of a result as described above, it is necessary to calculate the probability of another node of a result first. Therefore, the experimental content decision unit 30 decides that an experiment should be performed first (preferentially) on the node of the result depending only on the node of the operation.

In the case where the above experimental process has been performed, for example, the method described in PTL 1 requires experiments to be performed O(2⁶) times, while the experimental design optimization device 100 according to this exemplary embodiment requires experiments to be performed only O(2³*4) times. Generally speaking, in the case where experiments need to be performed O(2ⁿ) times exhaustively, the experimental design by the experimental design optimization device 100 of this exemplary embodiment requires experiments to be performed only O(|V|2^{{maxindeg}}) times, where |V| is the number of vertices and maxindeg is the maximum in-degree (the maximum number of branches that enter a single vertex). This means that the number of times of experimental operations can be suppressed linearly relative to the number of vertices for a graph in which maxindeg is suppressed with a constant. O(2ⁿ) is an exponential order for n and therefore it can be said that the number of experiments can be significantly reduced by an experimental design with the cause-and-effect graph used in an effective manner.

Although each node is assumed to take a binary value in the above experimental operation, it can be easily expanded also in the case of multiple values. Furthermore, in the above operation, the number of experiments is divided and Tᵢ sample is supposed to be used to estimate the conditional probability of the i-th node. Also during performing the experiment of the Tᵢ sample, however, data can be acquired with respect to, for example, the (i+1)th vertex and can also be estimated. Particularly, although the values are not specified for x₄ to x₆ when u₁ is estimated, random operations are also performed with respect to x₄ to x₆ to measure u₂ and u₃, thereby enabling the efficiency of the experiments to be increased.

The operation procedure for the concrete example has been described hereinabove. An algorithm for a general graph will be described below. A graph G=(V, E) is given as an input, first, where V is a vertex set and E is a set of directional branches. The graph is a DAG and it is assumed that no branch enters a vertex set X (a subset of V) for which an operation is able to be performed. When the graph and the total number of experiments are given, Cᵢ and Tᵢ can be calculated for each vertex as described above.

The following procedure is repeated. S indicates a vertex set for which a conditional probability has already been estimated. In the initial state before starting an experiment, S=X. Then, a vertex whose entering branch comes from only S is always present outside S. One of such vertices is selected and is referred to as “u.” For the vertex, the following experimental operation is performed, a conditional probability is estimated, and then this vertex is added to S. In the above example, u₁ and u₂ are selectable in an initial state, u₃ is becomes selectable after the end of the estimation of u₂, and u₄ becomes selected after the end of the estimation of u₁, u₂, and u₃.

The experimental operations are as described below. From the assumption, S includes the parent nodes of u, v₁ to vₖ. Therefore, the conditional probability P(v₁, . . . , vₖ|x₁, . . . , xₙ) obtained in the case where the operation is performed for X can be calculated by using the same calculation method as the above equation 1. Therefore, with respect to a combination of each {0, 1}^{k} of (v₁, . . . , vₖ), an experimental operation for x₁, . . . , xₙ having the highest probability of achieving the combination is able to be calculated. This operation is performed Tᵢ/Cᵢ times to estimate the conditional probability P(u|(v₁, . . . , vₖ)=W) for each combination W⊂{0, 1}^{k}. Thereby, the estimation of the conditional probability with respect to u is completed.

The output unit 40 outputs the experimental content (specifically, the order in which the plurality of experimental operations are to be performed) decided by the experimental content decision unit 30.

The storage unit 50 is implemented by, for example, a magnetic disk unit. Furthermore, the first reception unit 10, the second reception unit 20, the experimental content decision unit 30, and the output unit 40 are implemented by the CPU of a computer operating according to a program (an experimental design optimization program). For example, the program may be stored in the storage unit 50, and the CPU may read the program and operate as the first reception unit 10, the second reception unit 20, the experimental content decision unit 30, and the output unit 40 according to the program. Furthermore, the functions of the experimental design optimization device may be provided in the form of Software as a Service (SaaS).

Furthermore, each of the first reception unit 10, the second reception unit 20, the experimental content decision unit 30, and the output unit 40 may be implemented by dedicated hardware. Each of the first reception unit 10, the second reception unit 20, the experimental content decision unit 30, and the output unit 40 may be implemented by a general-purpose or dedicated circuitry. Incidentally, the general-purpose or dedicated circuitry may be composed of a single chip or may be composed of a plurality of chips connected through a bus. Furthermore, in the case where some or all of the components of each device are implemented by a plurality of information processors, circuitries, or the like, the plurality of information processors, circuitries, or the like may be centralized or may be distributed. For example, the information processors, circuitries, or the like may be implemented in a form of connection with each other via a communication network such as a client and server system, a cloud computing system, or the like.

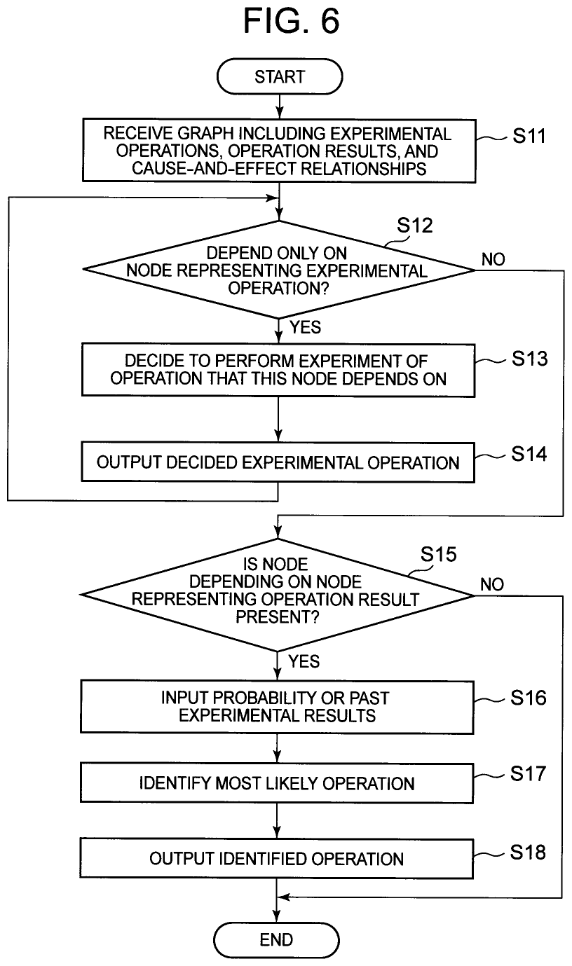

Subsequently, an operation of the experimental design optimization device of this exemplary embodiment will be described. FIG. 6 is a flowchart illustrating an example of operation of the experimental design optimization device of this exemplary embodiment.

First, the first reception unit 10 receives, as an input, a graph including nodes representing experimental operations and operation results and edges representing cause-and-effect relationships between the experimental operations and the operation results (step S11). The experimental content decision unit 30 decides whether or not the node depending only on the node representing the experimental operation is present in the input graph (step S12). If the node depending only on the node representing the experimental operation is present (Yes in step S12), the experimental content decision unit 30 decides to perform an experiment of the operation that this node depends on (step S13). Then, the output unit 40 outputs the decided experimental operation (step S14). Thereafter, the processes of step S12 and subsequent steps are repeated. In addition, the second reception unit 20 sequentially receives, as inputs, experimental results based on the output experiments.

On the other hand, unless the node depending only on the node representing the experimental operation is present (No in step S12), the experimental content decision unit 30 decides whether or not a node depending on a node representing an operation result is present (step S15). If the node depending on the node representing the operation result is present (Yes in step S15), the second reception unit 20 inputs a probability representing a cause-and-effect relationship with the node representing the result or past experimental results (step S16).

The experimental content decision unit 30 identifies the most likely operation in order to achieve a combination of the input values on the basis of the input probability or experimental results (step S17). The output unit 40 then outputs the identified operation (step S18). Thereafter, the processes of step 15 and subsequent steps are repeated. Moreover, the second reception unit 20 sequentially receives, as an input, experimental results based on the output experiment.

On the other hand, unless the node depending on the node representing the operation result is present (No in step S15), the processing ends.

As described above, in this exemplary embodiment, the first reception unit 10 receives, as an input, a graph including a plurality of nodes representing experimental operations, a plurality of nodes representing operation results, and edges representing cause-and-effect relationships between the experimental operations and the operation results. Moreover, the second reception unit 20 receives, as an input, either information indicating the degree of cause-and-effect relationship between each experimental operation and each operation result, or past experimental results from which the strength of each cause-and-effect relationship can be estimated. Moreover, on the basis of the input received by the first reception unit 10 and the information received by the second reception unit 20, the experimental content decision unit 30 and the output unit 40 output the order in which a plurality of the experimental operations are to be performed . Therefore, an experimental design can be optimized in consideration of a cause-and-effect relationship present behind.

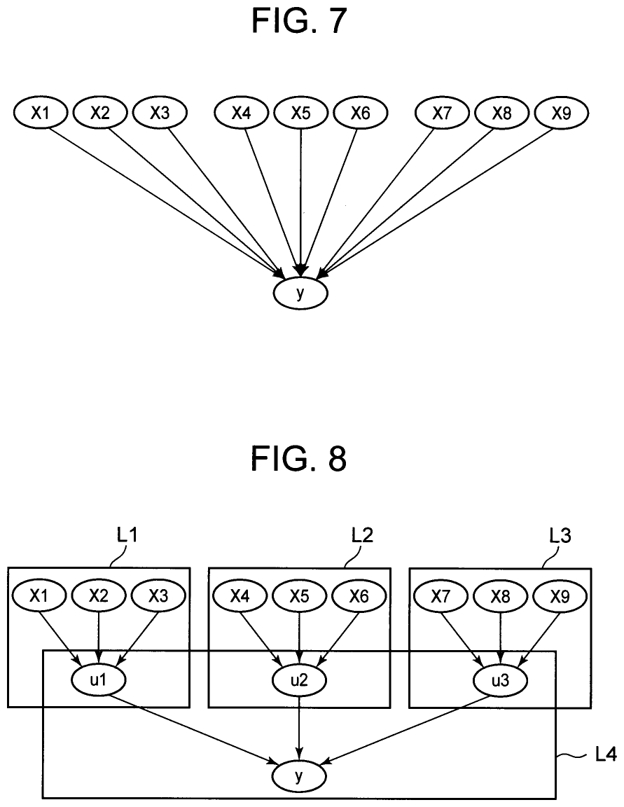

For example, it is also possible to create an experimental design only in consideration of the operations and the final result, without considering the results in the middle of operations and the cause-and-effect relationships between the operations and the results. FIG. 7 is an explanatory diagram illustrating an example of an experimental design. For example, in the case where each operation xi illustrated in FIG. 7 takes a binary value, the number of combinations of experimental operation types reaches as high as 2ⁱ, and therefore the number of experiments exponentially increases (O(2ⁿ): n is the number of types of drug, for example).

On the other hand, in this exemplary embodiment, an experimental design is created in consideration of, for example, a graph structure and cause-and-effect relationships as illustrated in FIG. 3. FIG. 8 is an explanatory diagram illustrating an example of the number of experiments. For example, an experiment is made on dependency on u₁ by operating x₁, x₂, and x₃ with respect to the L1 portion in FIG. 8. The number of experiments is O(2^{k})=O(1) (k=3 in this specification). The same applies to the L2 and L3 portions. With respect to the L4 portion, a combination of x₁ to x₉ likely to operate u₁, u₂, and u₃ can also be identified. Accordingly, y is estimated by an operation with the identified combination. From the above description, if the number of nodes is |V|, it is understood that an experiment can be performed with O(|V|). In other words, the experimental design optimization device of this exemplary embodiment enables a reduction in the number of experiments.

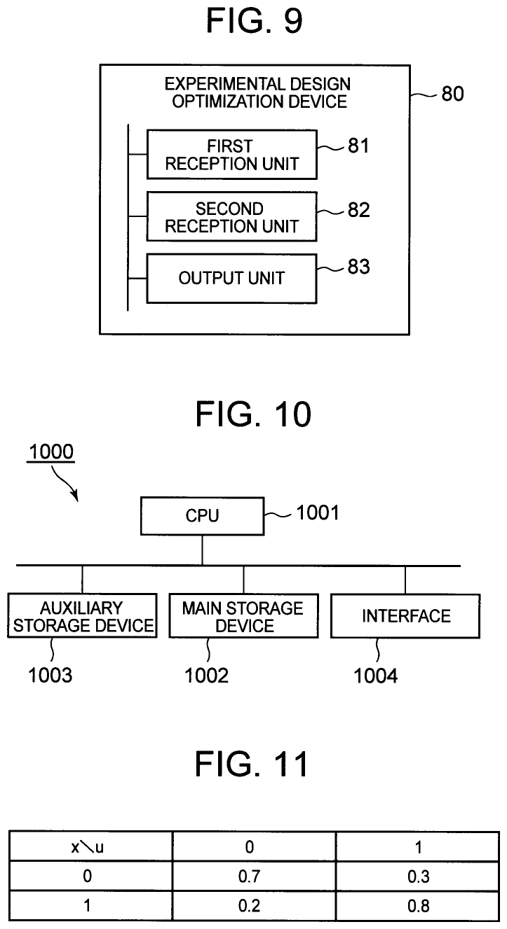

Subsequently, an outline of the present invention will be described. FIG. 9 is a block diagram illustrating an outline of an information processing system according to the present invention. An experimental design optimization device 80 according to the present invention includes: a first reception unit 81 (for example, the first reception unit 10) that receives, as an input, a graph including: a plurality of nodes representing experimental operations (for example, a node xᵢ); a plurality of nodes representing operation results (for example, a node uⱼ); and edges representing cause-and-effect relationships between the experimental operations and the operation results; a second reception unit 82 (for example, the second reception unit 20) that receives, as an input, either information indicating the degree of cause-and-effect relationship between each experimental operation and each operation result (for example, a probability) or past experimental results from which the strength of each cause-and-effect relationship can be estimated; and an output unit 83 (for example, the experimental content decision unit 30 and the output unit 40) that outputs the order in which a plurality of the experimental operations are to be performed on the basis of the input received by the first reception unit 81 and the information received by the second reception unit 82.

The above configuration enables optimization of an experimental design in consideration of a cause-and-effect relationship present behind.

Furthermore, the output unit 83 may identify the most likely operation in order to achieve a combination of values input for nodes representing results.

Moreover, the output unit 83 may calculate an implementation probability of values that can be taken by the nodes representing the results on the basis of the past experimental results and may identify the operation that achieves the highest implementation probability of the values that can be taken.

Furthermore, the output unit 83 may output a plurality of nodes depending only on the nodes representing the experimental operations, as nodes able to be experimented in parallel.

Furthermore, the output unit 83 may decide the number of experiments for each type of experiments according to the number of types of the experiments, each of which is identified for each node representing a result, for a predetermined number of all experiments.

Moreover, the output unit 83 may decide to preferentially experiment a node of a result depending only on a node of an operation.

FIG. 10 is a schematic block diagram illustrating the configuration of a computer according to at least one exemplary embodiment. A computer 1000 includes a CPU 1001, a main storage device 1002, an auxiliary storage device 1003, and an interface 1004.

The above experimental design optimization device is installed in the computer 1000. Then, the operation of each processing unit described above is stored in the auxiliary storage device 1003 in the form of a program (the experimental design optimization program). The CPU 1001 reads out the program from the auxiliary storage device 1003, develops the program in the main storage device 1002, and performs the above processing according to the program.

In at least one exemplary embodiment, the auxiliary storage device 1003 is an example of a non-transitory tangible medium. As other examples of the non-transitory tangible medium, there are cited a magnetic disk, a magnetic optical disk, a CD-ROM, a DVD-ROM, a semiconductor memory, or the like connected via the interface 1004. Moreover, in the case where the program is distributed to the computer 1000 via communication lines, the computer 1000, which has received the distributed program, may develop the program to the main storage device 1002 and perform the above processing.

Furthermore, the program may be for use in implementing some of the aforementioned functions. Moreover, the program may be one for implementing the aforementioned functions by a combination with another program already stored in the auxiliary storage device 1003, which is so-called a differential file (a differential program).

Some or all of the above exemplary embodiments can be also described as in the following Supplementary notes, but are not limited thereto.

(Supplementary note 1) An experimental design optimization device including: a first reception unit that receives, as an input, a graph including: a plurality of nodes representing experimental operations; a plurality of nodes representing results of the operations; and edges representing cause-and-effect relationships between the experimental operations and the operation results; a second reception unit that receives, as an input, either information indicating the degree of cause-and-effect relationship between the experimental operation and the operation result or past experimental results from which the strength of each cause-and-effect relationship can be estimated; and an output unit that outputs the order in which a plurality of the experimental operations are to be performed on the basis of the input received by the first reception unit and the information received by the second reception unit.

(Supplementary note 2) The experimental design optimization device according to Supplementary node 1, wherein the output unit identifies the most likely operation in order to achieve a combination of values input for the nodes representing the results.

(Supplementary note 3) The experimental design optimization device according to Supplementary note 2, wherein the output unit calculates an implementation probability of values that can be taken by the nodes representing the results on the basis of the past experimental results and identifies an operation that achieves the highest implementation probability of the values that can be taken.

(Supplementary note 4) The experimental design optimization device according to any one of Supplementary notes 1 to 3, wherein the output unit outputs a plurality of nodes depending only on the nodes representing the experimental operations, as nodes able to be experimented in parallel.

(Supplementary note 5) The experimental design optimization device according to any one of Supplementary notes 1 to 4, wherein the output unit decides the number of experiments for each type of the experiments according to the number of types of experiments, which are identified for each of the nodes representing the results, on a predetermined number of all experiments.

(Supplementary note 6) The experimental design optimization device according to any one of Supplementary notes 1 to 5, wherein the output unit decides to preferentially experiment a node of a result depending only on a node of an operation.

(Supplementary note 7) An experimental design optimization method including the steps of: receiving, as an input, a graph including: a plurality of nodes representing experimental operations; a plurality of nodes representing results of the operations; and edges representing cause-and-effect relationships between the experimental operations and the operation results; receiving, as an input, either information indicating the degree of cause-and-effect relationship between the experimental operation and the operation result or past experimental results from which the strength of each cause-and-effect relationship can be estimated; and outputting the order in which a plurality of the experimental operations are to be performed on the basis of the received graph and the information indicating the degree or the experimental results.

(Supplementary note 8) The experimental design optimization method according to Supplementary note 7, wherein the most likely operation is identified in order to achieve a combination of values input for the nodes representing the results.

(Supplementary note 9) An experimental design optimization program for causing a computer to perform: a first reception process of receiving, as an input, a graph including: a plurality of nodes representing experimental operations; a plurality of nodes representing results of the operations; and edges representing cause-and-effect relationships between the experimental operations and the operation results; a second reception process of receiving, as an input, either information indicating the degree of cause-and-effect relationship between the experimental operation and the operation result or past experimental results from which the strength of each cause-and-effect relationship can be estimated; and an output process of outputting the order in which a plurality of the experimental operations are to be performed on the basis of the input received by the first reception process and the information received by the second reception process.

(Supplementary note 10) The experimental design optimization program according to Supplementary note 9, wherein the output process includes identifying the most likely operation in order to achieve a combination of values input for the nodes representing the results.

### REFERENCE SIGNS LIST

10 First reception unit

20 Second reception unit

30 Experimental content decision unit

40 Output unit

50 Storage unit

100 Experimental design optimization device

1. An experimental design optimization device comprising:
a hardware including a processor;
a first reception unit, implemented by the processor, that receives, as an input, a graph including: a plurality of nodes representing experimental operations; a plurality of nodes representing results of the operations; and edges representing cause-and-effect relationships between the experimental operations and the operation results;
a second reception unit, implemented by the processor, that receives, as an input, either information indicating the degree of cause-and-effect relationship between the experimental operation and the operation result or past experimental results from which the strength of each cause-and-effect relationship is used for estimation; and
an output unit, implemented by the processor, that outputs the order in which a plurality of the experimental operations are to be performed on the basis of the input received by the first reception unit and the information received by the second reception unit.

2. The experimental design optimization device according to claim 1, wherein the output unit identifies the most likely operation in order to achieve a combination of values input for the nodes representing the results.

3. The experimental design optimization device according to claim 2, wherein the output unit calculates an implementation probability of values that can be taken by the nodes representing the results on the basis of the past experimental results and identifies an operation that achieves the highest implementation probability of the values that can be taken.

4. The experimental design optimization device according to claim 1, wherein the output unit outputs a plurality of nodes depending only on the nodes representing the experimental operations, as nodes able to be experimented in parallel.

5. The experimental design optimization device according to claim 1, wherein the output unit decides the number of experiments for each type of the experiments according to the number of types of experiments, which are identified for each of the nodes representing the results, on a predetermined number of all experiments.

6. The experimental design optimization device according to claim 1, wherein the output unit decides to preferentially experiment a node of a result depending only on a node of an operation.

7. An experimental design optimization method comprising:
receiving, as an input, a graph including: a plurality of nodes representing experimental operations; a plurality of nodes representing results of the operations; and edges representing cause-and-effect relationships between the experimental operations and the operation results;
receiving, as an input, either information indicating the degree of cause-and-effect relationship between the experimental operation and the operation result or past experimental results from which the strength of each cause-and-effect relationship is used for estimation; and
outputting the order in which a plurality of the experimental operations are to be performed on the basis of the received graph and the information indicating the degree or the experimental results.

8. The experimental design optimization method according to claim 7, wherein the most likely operation is identified in order to achieve a combination of values input for the nodes representing the results.

9. A non-transitory computer readable information recording medium storing an experimental design optimization program, when executed by a processor, that performs a method for:
receiving, as an input, a graph including: a plurality of nodes representing experimental operations; a plurality of nodes representing results of the operations; and edges representing cause-and-effect relationships between the experimental operations and the operation results;
receiving, as an input, either information indicating the degree of cause-and-effect relationship between the experimental operation and the operation result or past experimental results from which the strength of each cause-and-effect relationship is used for estimation; and
outputting the order in which a plurality of the experimental operations are to be performed on the basis of the received graph and the information indicating the degree or the experimental results.

10. The non-transitory computer readable information recording medium according to claim 9, wherein the most likely operation is identified in order to achieve a combination of values input for the nodes representing the results.
